(19) United States
(12) Patent Application Publication
(10) Pub. No.: US 2024/0375425 A1
(43) Pub. Date: Nov. 14, 2024

(54) SECURITY FEATURE FOR A VALUE DOCUMENT, VALUE DOCUMENT AND METHOD OF PRODUCING A SECURITY FEATURE

(71) Applicant: GIESECKE+DEVRIENT EPAYMENTS GMBH, Munchen (DE)

(72) Inventors: Cristina FABIAN, Garching (DE); Klaus KOHL, Miesbach (DE); Gunter ENDRES, Passau (DE)

(21) Appl. No.: 18/557,324

(22) PCT Filed: Apr. 26, 2022
(86) PCT No.: PCT/EP2022/025182

§ 371 Date: Oct. 26, 2023

(30) Foreign Application Priority Data
Apr. 27, 2021 (DE) 10 2021 002 225.4

(51) Int. Cl. B42D 25/41; B42D 25/23; B42D 25/29; B42D 25/351; B42D 25/378

(52) U.S. Cl. CPC B42D 25/41; B42D 25/378; B42D 25/23; B42D 25/29; B42D 25/351

(57) ABSTRACT

A security feature for a value document, into which positives of a representation are introduced by at least one laser beam, includes at least one laser-sensitive recording layer which is transparent in the visible spectral range, light-diffracting or light-refracting structures that are arranged on a first side of the recording layer, a positive and an image-processed positive. One of the positives or the image-processed positive is introduced into the at least one recording layer by a laser beam from a first direction through the light-diffracting or light-refracting structures and is visible when viewed from the first direction. The other of the positives or the image-processed positive is introduced into the at least one recording layer by a laser beam from a second direction and is visible when viewed from the second direction.

The invention relates to a security feature for a value document, a value document and a method of producing a security feature.

Documents of value or data carriers, such as passport and identification documents, identification cards, credit cards, bank cards and the like, are being used to an increasing extent in public areas, but also in internal company areas.

For some time, it has been known to provide such documents of value or even banknotes with lens screens, for example in the form of lenticular lenses. Such structures provide the documents of value with optically variable effects such as tilting images, which are also intended to provide protection against reproduction.

The verification of two images merging into one another is not always possible with 100% certainty, since, during the transition between two images, the presentation is often not clearly recognizable.

Therefore, it is an object of the present invention to improve the representation of such security features.

This object is achieved by a security feature for a value document, a value document and a method of producing a security feature according to the independent patent claims, respectively. Advantageous embodiments and further developments of the invention are defined in the dependent claims.

A security feature according to the invention for a value document, into which positives of a representation are introduced by at least one laser beam, comprises at least one laser-sensitive recording layer that is transparent in the visible spectral range, light-diffracting or light-refracting structures arranged on a first side of the recording layer, a positive and an image-processed positive, wherein one of the positives or the image-processed positive is introduced into the at least one recording layer with a laser beam from a first direction through the light-diffracting or light-refracting structures and is recognizable when viewed from the first direction, and wherein the other of the positives or the image-processed positive is introduced into the at least one recording layer with a laser beam from a second direction and is recognizable when viewed from the second direction.

A basic idea of the present invention is that the security feature is a combination of a positive and an image-processed positive of a single, that is, the identical, representation. Atilt image with such positive and the image-processed positive is easy to recognize, since there is no color space change. By keeping the representation always in the positive, a tilt image is created with a smooth or flowing transition, which even allows for verification with a standard card reader. The positive and the image-processed positive may each be considered as an identifier of the security feature. The two together may produce a tilt image.

The positive and the image-processed positive may both be introduced by light-diffracting or light-refracting structures. Alternatively, one of the two may be introduced through the light-diffracting or light-refracting structures and the other from a reverse side. This allows a combination of a viewing angle-dependent marking introduced by a lens raster and a viewing angle-independent marking introduced from a reverse side.

The changes in the optical properties of the recording layer or the security feature may be visible in transmitted light and/or reflected light. Furthermore, the positive or the image-processed positive may be in a rasterized form, wherein the raster elements may be formed by, for example, rod-shaped pixels. The positive or image-processed positive also comprises multiple identifiers such as single numbers or letters, but also biometric features such as a portrait or a fingerprint.

Thus, the security feature proposed here has the advantage of enabling simplified identifiability and/or verification of the authenticity of the security feature.

It may be provided that a further laser-sensitive recording layer transparent in the visible spectral range is provided, wherein the positive is introduced into the one recording layer and the image-processed positive is introduced into the further recording layer. This may be used to separate the two identifiers. In addition, different layers or dopants may be used, and thus different effects may be realized.

It may further be provided that a luminescent material is introduced between the positive and the image-processed positive. This allows the security feature to be highlighted. In particular, photoluminescence in the form of fluorescence or phosphorescence is considered here. For example, if white fluorescence is used, when viewed under a UV light, an effect may be achieved as if a light is turned on, or a beam of light is focused on the security feature. In this manner, easier and clearer recognition and identifiability, along with increased counterfeit protection, may be achieved.

It may be provided that one of the positives or the image-processed positive is a dynamic representation and that the other is a static representation. The static image or representation will be introduced from the side facing away from the lens, the dynamic image or representation from the lens side. The static image may be a main image. Moreover, the positive and the image-processed positive may each be a dynamic representation. Then, both the positive and the image-processed positive are introduced over the light-diffracting or light-refracting structures. For example, the two angles for introducing the positive or the image-processed positive may be offset by 90°. A further variant is that a marking is introduced at an angle of 90°, i.e., perpendicular to the light-diffracting or light-refracting structures. Then, it may be advantageous to increase the energy of a laser beam, for example.

It may be further provided that the image-processed positive of the representation has an increased contrast of the representation. By means of filters or algorithms of image processing, the contrast or the image depth of the representation may be altered. This means that the image-processed positive may be an overdrawn positive, for example. For example, the image-processed positive may be a relief representation of the positive.

It may be provided that one of the positives or image-processed positive is a biometric representation and that the other is a contour of such biometric representation. The dynamic image may be the contour or outline of the main image, which may be a photo, for example, or vice versa. A combination with CLIP-ID, as disclosed for example in DE 10 2018 007 207 B4, is also possible.

It may further be provided that the positive and/or the image-processed positive comprise personal data, such as a signature, a date of birth, a portrait or the like. In principle, all graphically displayable elements may be represented by individual pixels activated by laser irradiation.

The positive and/or the image-processed positive may comprise data relating to the value document, such as a validity period, a card number, information on the issuing authority or the like. In principle, all graphically displayable elements may be represented by individual pixels activated by laser irradiation.

It may further be provided that the light-diffracting or light-refracting structures comprise a surface relief in the form of a lens raster. By means of a lens raster with a number or plurality of individual lenses, such as spherical lenses, rod lenses and/or cylindrical lenses, a good optical representation and fluid movement between the markings may be achieved.

A value document according to the invention, such as a banknote, identification card or the like, comprises a substrate with an opening in which a data carrier as described above is at least partially arranged as a security element.

The data carrier may be located completely in the opening. The opening with the data carrier located therein may be covered, for example, by means of one or more films. Otherwise, the same benefits and modifications as described previously apply.

A method of producing a security feature according to the invention comprises the following steps:
providing a positive of a representation,
providing an image-processed positive of the representation,
introducing one of the positives or the image-processed positive with a laser beam from a first direction through light-diffracting or light-refracting structures into the at least one recording layer, such that the one of the positives or the image-processed positive is recognizable when the security feature is later viewed from the first direction, and
introducing the other of the positives or the image-processed positive into the at least one recording layer with a laser beam from a second direction, such that the other of the positives or the image-processed positive is recognizable when the security feature is later viewed from the second direction.

The same benefits and modifications as previously described apply.

The present invention is described below by way of example with reference to the accompanying drawings. Therein, the following are shown:

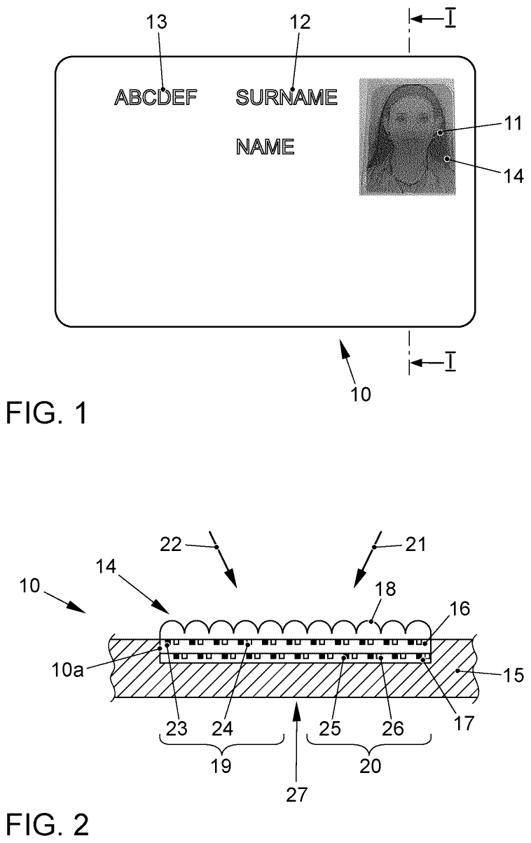

FIG. 1: a top view of a value document;

FIG. 2: a sectional view of the value document from FIG. 1 according to line I-I;

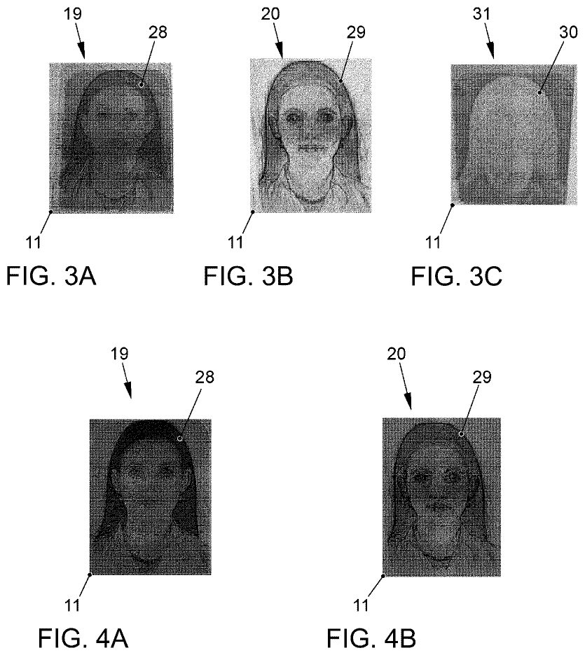

FIGS. 3a, 3b, 3c: a principle representation of a security feature with a front side and a negative reverse side provided with a positive and an image-processed positive;

FIGS. 4a, 4b: a principal representation of a security feature with a positive and with an image-processed positive; and

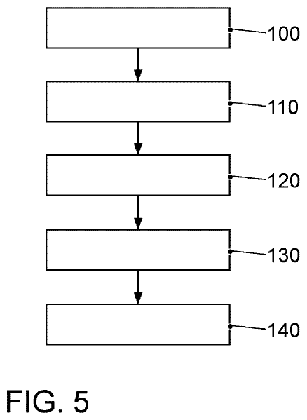

FIG. 5: a method of producing a security feature for a value document.

FIG. 1 shows a top view of a value document 10 in schematic view. The value document 10 may be a bank bill, a passport or identification document or the like. In the example shown in FIG. 1, the value document 10 is an identification document.

The value document 10 contains a security feature 11 in the form of a portrait of the cardholder, along with other personal data 12 such as the first and last name of the cardholder. In addition, the identification card may contain other data 13, such as date of birth, nationality, issuing authority, date of issue and the like. The security feature 11 is at least partially arranged in an opening 10a of the value document 10.

In the security feature 11 in the form of a portrait of the value document 10, a tilting image 14 is arranged, which contains two different pieces of information or markings each inscribed by means of a laser beam in the form of a positive 19 of a representation and an image-processed positive 20 of the representation. In this example, the two markings are part of the security feature 11, or the two markings form the security feature 11.

In contrast to the graphic representation of FIG. 1, the two markings are not visible simultaneously when viewing the value document 10, but are only visible by tilting the value document 10 at a different tilt angle in each case.

The basic structure of the tilt image 14 will now be explained in more detail with reference to FIG. 2, which shows a section through the value document 10 along line I-I of FIG. 1.

The value document 10 contains a transparent card body 15 and at least one, preferably two, laser-sensitive recording layers 16 and 17. The card body 15 may be transparent or partially transparent. Likewise, the card body 15 may be opaque, in which case a transparent or partially transparent window is provided in the region of the two laser-sensitive recording layers 16 and 17.

Like the substrate or card body 15, the recording layers 16 and 17 are transparent or partially transparent in the visible spectral range. The recording layers 16 and 17 may be a sub-region of the card body 15 or separate layers.

Here, the value document 10 comprises a surface relief in the form of a lens raster 18 on a top side or front side. The lens raster 18 is arranged above the recording layer 16 and may be arranged directly on the recording layer 16. Thus, the recording layer 16 is located between the lens raster 18 and the recording layer 17. Similarly, the surface relief in the form of the lens raster 18 may be arranged on a bottom side or reverse side of the recording layers 16 and 17. Then, the lens raster 18 is located in the interior of the card body 15.

In this example, a lens raster 18 with individual lenses such as spherical lenses, rod lenses and/or cylindrical lenses is used. Instead of lenses, light-diffracting and/or light-refracting structures may also be used.

A first marking in the form of a positive 19 of a representation is introduced into the recording layer 16, which may be referred to as the first recording layer. A second marking in the form of an image-processed positive 20 of the same representation is introduced into the recording layer 17, which may be referred to as the second recording layer. The two recording layers 16 and 17 extend parallel to a major surface of the value document 10 and may be directly adjacent to one another.

Here, the markings 19 and 20 introduced into the tilt image 14 contain personal information and are inscribed into the recording layers 16 and 17 only after the lens raster 18 has been applied, for example by means of a pulsed infrared laser. This applies at least to the first marking 19 in the recording layer 16.

For this purpose, the laser beam is directed onto the lens raster 18 from different directions 21 or 22. The individual lenses of the lens raster 18 focus the laser beam on different small sub-regions 23 or 24 of the recording layer 16, depending on the direction of irradiation.

The effect of the laser beam locally alters the optical properties of the recording layer 16; for example, the layer is locally blackened. When the value document 10 is later viewed from the direction 21, the blackened sub-regions 23 are recognizable due to the focusing effect of the individual lenses, which form an image for the viewer. Accordingly, the sub-regions 24 inscribed from the viewing direction 22 are discernible and combine to form an image for the viewer.

The value document 10 may comprise additional layers, such as one or more protective layers or functional layers provided with other security elements. The transparency of the value document 10 is to be maintained in the region of the inscribed positive 19 and the inscribed image-processed positive 20.

Th recording layer 17 is described similarly to the recording layer 16. Analogous to the recording layer 16, the recording layer 17 also comprises several small sub-regions 25 and 26. The various sub-regions 25 and 26 are arranged in a matrix-like arrangement in the recording layer 17.

The second marking, in the form of the image-processed positive 20, is also inscribed into the recording layer 17 by means of a laser such as a pulsed infrared laser.

The image-processed positive 20 may be inscribed by means of the lens raster 18, for example from the direction 22. In this case, the positive 19 is inscribed from the direction 21. Both positives 19 and 20 are then angle-dependent. The result is a tilted image from the viewing directions 21 and 22.

Similarly, it is possible to introduce the image-processed positive 20 into the recording layer 17 from a bottom side by means of the laser beam. The bottom side is the side of the value document 10 that faces the lens raster 18. In this manner, the image-processed positive 20 is introduced into the recording layer 17 without any distortion.

Thus, when viewing the value document 10 from the front side, a viewer sees the viewing angle-dependent positive 19 of the recording layer 16 and the viewing angle-independent image-processed positive 20 of the recording layer 17. While, as described, the positive 19 is recognizable selectively in terms of the viewing angle from one or both directions 21 and 22, the image-processed positive 20 is recognizable from all directions, including the two directions 21 and 22.

Thus, a tamper-proof tilt image 14, which has a further piece of information underneath, may be generated. In this example, the two recording layers 16 and 17 are implemented as the two recording layers. Likewise, it is possible to provide a single recording layer, in which the positive 19 is inscribed by means of the lens raster 18 and the image-processed positive 20 is inscribed by means of the lens raster 18 or from the reverse side.

This allows the combination of a static with a dynamic image or representation. The static image corresponds to the image-processed positive 20 and the dynamic image corresponds to the positive 19. Checking this security feature is simplified, since the dynamic image tilting away under the lens can very easily overlap with the static image without leaving the positive color space. Thus, a check for the matching of recognition-relevant features is simple and may be performed with an automated card reader.

A luminescent material may be introduced between the positive and the image-processed positive 20. With luminescence, the substance is brought into an excited state by externally supplied energy and emits light as it transitions to its ground state, emitting photons. In particular, photoluminescence in the form of fluorescence or phosphorescence is considered here. The luminescent material may be integrated either by printing or by means of a film or insert, preferably as white fluorescence. The luminescent material allows easy recognition of the information, for example, for border officials or police officers during a passport check or a driver's license check using a UV lamp.

FIG. 3 show a principal representation of a security feature 11 with a positive and a front side provided with a contour and a negative reverse side.

In FIG. 3a, the security feature 11 is shown with its front side, i.e., the positive 19. Here, the positive 19 comprises a positive representation 28. The positive representation 28 consists of a plurality of image dots or pixels introduced by a laser beam as previously described. Since the first marking 19 was introduced by means of the lens raster, the first marking 19 is viewing angle-dependent.

FIG. 3b also shows a representation of the front side of the security feature 11 with an image-processed positive 20 in the form of a contour 29 that surrounds the positive representation 28 of FIG. 3a. For example, the positive representation 28 of the positive 19 shown in FIG. 3a may be shown from the viewing angle or direction 21. Accordingly, the representation of FIG. 3b may be shown from the viewing angle or direction 22. Thus, depending on the viewing angle or direction 21 or 22, the positive representation 28 or the contour 29 is emphasized.

FIG. 3c shows a view of an optional reverse side of the security feature 11 or a third marking 31. In addition to the two positives 19, 20 of the front side, the third marking 31 is located on the reverse side.

Here, the third marking 31 comprises a negative representation 30 of the positive representation 28 of FIG. 3a. Since the negative representation 30 of the third marking 31 has not been applied by means of the lens raster, the third marking 31 is a static representation.

On the other hand, the positive 19 and the image-processed positive 20, or the positive representation 28 and the contour 29, are dependent on the viewing angle. Thus, in this example of FIGS. 3, the security feature 11 is formed by the positive representation 28 and the contour 29 along with the negative representation 30.

FIG. 4 show a principal representation of a security feature 11 with a positive and a front side provided with a contour.

FIG. 4a shows a positive 19 with a positive representation 28. FIG. 4b shows the image-processed positive 20 with a contour 29. The positive contour 29 or the relief corresponds to an overdrawn image of the positive 19 with which the contrast along the edges of the positive 19 is increased or enhanced.

In turn, the positives 19 and 20 shown in FIGS. 4a and 4b are viewing angle-dependent. Accordingly, the positive 19 is only recognizable from a certain angle, for example the direction 21. On the other hand, the image-processed positive 20 is recognizable from a second viewing angle such as the direction 22.

All combinations of the positive representation 28 and the contour 29 in the positive 19 and the image-processed positive 20 are possible. A combination with a color separation as a CLIP ID is also possible.

In the above examples, the positive 19 and the image-processed positive 20 are shown as portrait representations or parts thereof. One or both positives 19, 20 may comprise any personal data, such as a signature, date of birth or the like. In addition, the positives 19 or 20 may comprise data related to the value document 10, such as a validity period, a card number, information on the issuing authority or the like.

FIG. 5 shows a method of producing a security feature 11 for a value document 10.

In a first step 100, at least one laser-sensitive recording layer 16, 17 that is transparent in the visible spectral range with a surface relief in the form of a lens raster 18 on a first side of the recording layer 16 is provided.

In a second step 110, a positive 19 of a representation 28 such as a portrait is provided.

In a third step 120, an image-processed positive 20 of the representation 28 is provided by means of image processing of the representation 28, such as increasing the contrast such that an outline or relief of the representation 28 is formed.

In a fourth step 130, one of the positives 19 or the image-processed positive 20 is introduced into the at least one recording layer 16, 17 with a laser beam from a first direction 21 by means of the lens raster 18, such that the one of the positives 19 or the image-processed positive 20 is recognizable when the security feature 11 is later viewed from the first direction 21

In a fifth step 140, the other of the positives 19 or the image-processed positive 20 is introduced into the at least one recording layer 16, 17 with a laser beam from a second direction 22, such that the other of the positives 19 or the image-processed positive 20 is recognizable when the security feature 11 is later viewed from the second direction 22

The sequence of steps is not necessarily limited to this order. For example, providing one or both of the positives 19, 20 may also be provided as a first or second step.

1-11. (canceled)

12. A security feature for a value document, into which positives of a representation are introduced by at least one laser beam, comprising
at least one laser-sensitive recording layer that is transparent in the visible spectral range,
light-diffracting or light-refracting structures arranged on a first side of the recording layer,
a positive and an image-processed positive,
wherein one of the positives or the image-processed positive is introduced into the at least one recording layer with a laser beam from a first direction through the light-diffracting or light-refracting structures and is recognizable when viewed from the first direction, and
wherein the other of the positives or the image-processed positive is introduced into the at least one recording layer with a laser beam from a second direction and is recognizable when viewed from the second direction.

13. The security feature according to claim 12, wherein a further laser-sensitive recording layer transparent in the visible spectral range is provided, wherein the positive is introduced into the one recording layer and the image-processed positive is introduced into the further recording layer.

14. The security feature according to claim 13, wherein a luminescent material is introduced between the positive and the image-processed positive.

15. The security feature according to claim 12, wherein one of the positives or the image-processed positive is a dynamic representation and that the other is a static representation.

16. The security feature according to claim 12, wherein the image-processed positive of the representation has an increased contrast of the representation.

17. The security feature according to claim 12, wherein one of the positives or image-processed positive is a biometric representation and that the other is a contour or relief of such biometric representation.

18. The security feature according to claim 12, wherein the positive and/or the image-processed positive comprise personal data, a date of birth, or a portrait.

19. The security feature according to claim 12, wherein the positive and/or the image-processed positive comprise data related to the value document, a card number, or information on the issuing authority.

20. The security feature according to claim 12, wherein the light-diffracting or light-refracting structures comprise a surface relief in the form of a lens raster.

21. A value document comprising a substrate with an opening in which a security feature according to claim 12 is at least partially arranged.

22. A method of producing a security feature for a value document, comprising the following steps:
providing at least one laser-sensitive recording layer transparent in the visible spectral range with light-diffracting or light-refracting structures on a first side of the recording layer,
providing a positive of a representation,
providing an image-processed positive of the representation,
introducing one of the positives or the image-processed positive with a laser beam from a first direction through the light-diffracting or light-refracting structures into the at least one recording layer such that the one of the positives or the image-processed positive is recognizable when the security feature is later viewed from the first direction, and
introducing the other of the positives or the image-processed positive with a laser beam from a second direction into the at least one recording layer, such that the other of the positives or the image-processed positive is recognizable when the security feature is later viewed from the second direction.
